(19) United States
(12) Patent Application Publication
(10) Pub. No.: US 2019/0130917 A1
(43) Pub. Date: May 2, 2019

(54) AUTOMATED ENRICHMENT OF SPEECH TRANSCRIPTION WITH CONTEXT

(71) Applicants: Oleg Pogorelik, Lapid (IL); Sean J. W. Lawrence, Bangalore (IN); Adel Fuchs, Ramat-Gan (IL); Denis Klimov, Beer Sheba (IL); Raizy Kellerman, Jerusalem (IL); Sapir Hamawie, Har Adar (IL); Sukanya Sundaresan, Bangalore (IN); Ayeshwarya Baliram Mahajan, Bengaluru (IN)

(72) Inventors: Oleg Pogorelik, Lapid (IL); Sean J. W. Lawrence, Bangalore (IN); Adel Fuchs, Ramat-Gan (IL); Denis Klimov, Beer Sheba (IL); Raizy Kellerman, Jerusalem (IL); Sapir Hamawie, Har Adar (IL); Sukanya Sundaresan, Bangalore (IN); Ayeshwarya Baliram Mahajan, Bengaluru (IN)

(21) Appl. No.: 16/234,542

(22) Filed: Dec. 27, 2018

(51) Int. Cl. G10L 17/00

(52) U.S. Cl. CPC G10L 17/005

(57) ABSTRACT

A text-only transcription of spoken input from one or more speakers is enhanced with context information that indicate the speakers' states, including physical, emotional, and mental conditions. Context information includes information sensed or otherwise gathered from the speakers' surroundings. The contextual information in the resulting enhanced transcription can facilitate a more accurate understanding of the speakers' intended meaning, and thus avoid misunderstandings that can be detrimental to the relationship between speaker and listener and avoid time consuming activity to rectify misunderstandings.

### BACKGROUND

Nowadays, it is possible to convert speech to text (speech transcription). Tools such as meeting assistants and dictation tools are used for creating text-only (textual) content. Transcribing speech out of context and/or without appropriate context can negatively affect understanding by the human reader and fool automated text transcription processing engines. Non-spoken cues and other details that are missing in a textual transcription can result in false positives in text processing engines, such as generating an incorrect meeting summary, sending false-positive alerts, etc.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 shows a high level system diagram of a transcription system in accordance with some embodiments of the present disclosure.

FIG. 2 illustrates some details of a transcription enhancer in accordance with some embodiments of the present disclosure.

FIG. 3 shows an example of a text-only transcription.

FIG. 4 shows a communication ladder diagram among components in a transcription system in accordance with some embodiments of the present disclosure.

FIGS. 5A, 5B, 5C, 5D show fragments of enhanced transcriptions generated in accordance with some embodiments of the present disclosure.

FIG. 6 is a flow chart highlighting operations for producing an enhanced transcription in accordance with some embodiments of the present disclosure.

FIG. 7 shows and example of an enhanced transcription file in accordance with some embodiments of the present disclosure.

FIG. 8 shows an illustration system to produce rendering of an enhanced transcription in accordance with some embodiments of the present disclosure.

FIG. 9 is a flow chart highlighting operations for rendering an enhanced transcription in accordance with some embodiments of the present disclosure.

FIG. 10 shows an example of information that can be controlled using an exposure policy in accordance with some embodiments of the present disclosure.

FIG. 11 shows an example for selecting an avatar in accordance with some embodiments of the present disclosure.

FIG. 12 shows a high level block diagram of a computer system in accordance with some embodiments of the present disclosure.

FIG. 13 shows a high level system diagram of a multi-speaker transcription system in accordance with some embodiments of the present disclosure.

FIG. 14 illustrates some details of a multi-speaker transcription enhancer in accordance with some embodiments of the present disclosure.

FIG. 15 is a high level block diagram of a summarization engine in accordance with some embodiments of the present disclosure.

### DETAILED DESCRIPTION

In some embodiments, the computer-readable storage medium in the apparatus further comprises instructions for controlling the one or more computer processors to be operable to generate an enhanced transcription of spoken input from a plurality of speakers, including: identifying each of the plurality of speakers; detecting when state changes occur among each of the plurality of speakers; generating data elements representative of context information associated with each of the plurality of speakers based on their state changes; and incorporating the data elements with a text-only transcription of the plurality of speakers' speech to add context to the text-only transcription.

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples, alone or in combination with other features described below, and may further include modifications and equivalents of the features and concepts described herein.

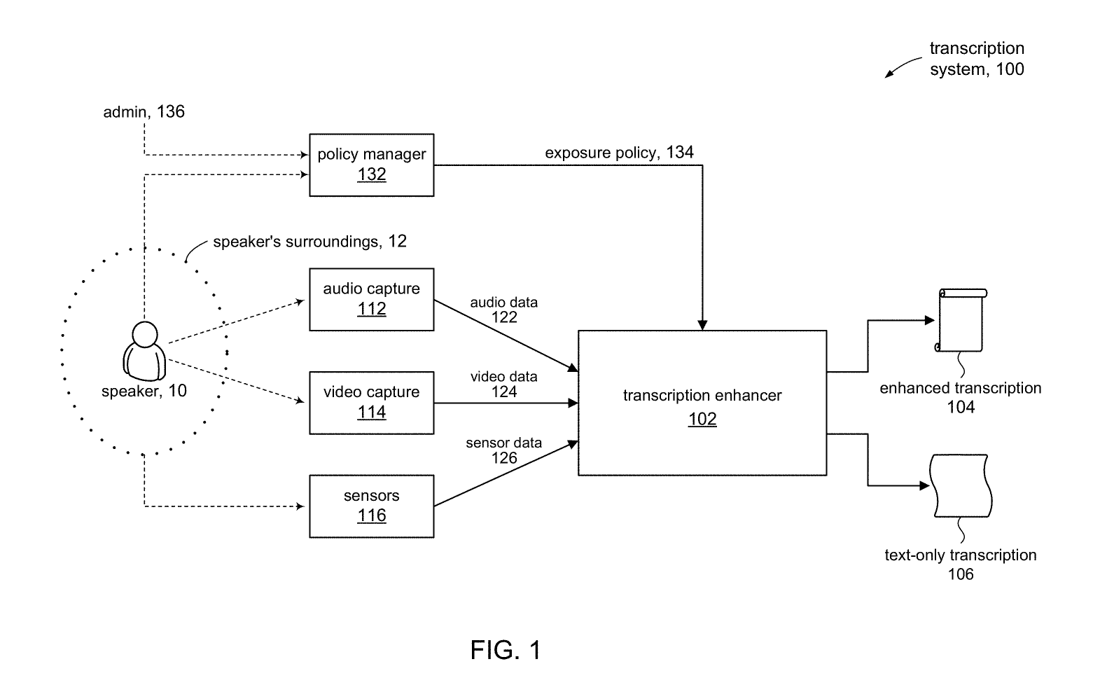

FIG. 1 shows a transcription system 100 in accordance with embodiments of the present disclosure. Generally, the transcription system 100 receives audio input from a speaker 10, and can produce a text-only transcription 106 of speech contained in the audio. In accordance with the present disclosure, the transcription system 100 can also produce an enhanced transcription 104 of the speech. In accordance with embodiments of the present disclosure, the transcription system 100 can record and otherwise capture various information of the speaker 10 and relating to the speaker's surroundings (environment) 12, in addition to audio from the speaker 10. The additional inputs can be provided to a transcription enhancer 102, which uses the additional inputs to enhance the text-only transcription 106 to produce the enhanced transcription 104.

In some embodiments, the transcription system 100 can include various data capture devices to capture and provide audio and additional inputs to the transcription enhancer 102. An audio capture device 112 can capture audio input from the speaker 10. For example, the audio capture device 112 can include a microphone that speaker 10 can wear or be near. The audio capture device 112 can output an audio data stream 122 that represents the captured audio from the speaker 10. In some embodiments, the audio data stream 122 can be real time in that it is produced concurrently while the speaker 10 is talking. In other embodiments, the captured audio input can be recorded and stored for future processing, in addition to the audio data stream 122 being provided in real time. In other embodiments, the captured audio input can be recorded and stored for future processing; the audio data stream 122 can be produced at a later time when the stored audio is played back.

A video capture device 114 (e.g., a video camera, a smartphone with a video camera, etc.) can capture video of the speaker 10. The video capture device 114 can output a video data stream 124 that represents the captured video. In some embodiments, the video data stream 124 can be real time in that it is produced concurrently while the speaker 10 is talking. In other embodiments, the captured video can be recorded and stored for future processing, in addition to the video data stream 124 being provided in real time. In other embodiments, the captured video can be recorded and stored for future processing; the video data stream 124 can be produced at a later time, for example, when the stored video is played back with the stored audio. In some embodiments, the audio capture device 112 and the video capture device 114 can be incorporated in a single device; for example, most video cameras and smartphones have audio and video capture components.

In accordance with some embodiments, data capture devices can include various sensors 116 to capture information about the speaker's surroundings 12. In some embodiments, for example, sensors 116 can include a global positioning device (Global Positioning System, GPS) or other location identifying device to provide information about the speaker's 10 location. For instance, in a conference setting, the speaker 10 may move about in the conference area; the GPS can track the speaker's 10 movement in the conference area. Sensors 116 can include devices to collect ambient conditions, such as temperature, humidity, lighting conditions, motion detection, odor detection, and the like. Sensors 116 can include audio sensors to capture ambient sounds other than from the speaker 10; for example, background noise from other people in the area, passing automobiles, and so on. The foregoing examples illustrate the broad range of sensing devices that sensors 116 that include. It will be appreciated that sensors 116 can include any sensing device that can capture information about the speaker's surroundings 12.

The sensor data 126 produce by sensors 116 can be real time in that it is produced concurrently while the speaker 10 is talking. The sensor data 126 can include time information in order to be synchronized with the audio data stream 122 and the video data stream 124. In some embodiments, the sensor data 126 can be recorded and stored for future processing, in addition to the sensor data 126 being provided in real time. In other embodiments, the sensor data 126 can be recorded and stored for future processing; the sensor data 126 can be produced at a later time, for example, when the stored audio and video is played back.

In accordance with the present disclosure, any kind of information about the speaker and their surroundings that can be captured and/or inferred from can serve as contextual information to add context and otherwise enhance a transcript of the speaker's words. However, there will be certain information (e.g., speaker's physical characteristics, medical information, and the like) that may not be appropriate (e.g., by personal standards or cultural/social norms) or legally permitted (e.g., by governmental regulations). In addition, standards and norms may change over time and can vary from one region to another. The transcription system 100 can include a policy manager 132 to identify and regulate the use of such information, and can provide the flexibility to add, modify, and delete restrictions on context information. An administrative entity 136 (e.g., a human resources manager) can access the policy manager 132 to set various policies and/or define constraints used by the system. In some embodiments, the speaker 10 themselves can access the policy manager 132 to control the exposure of their personal information. The policy manager 132 can generate an exposure policy 134 to the transcription enhancer 102 that controls the kind of information that can be incorporated into the enhanced transcription 104.

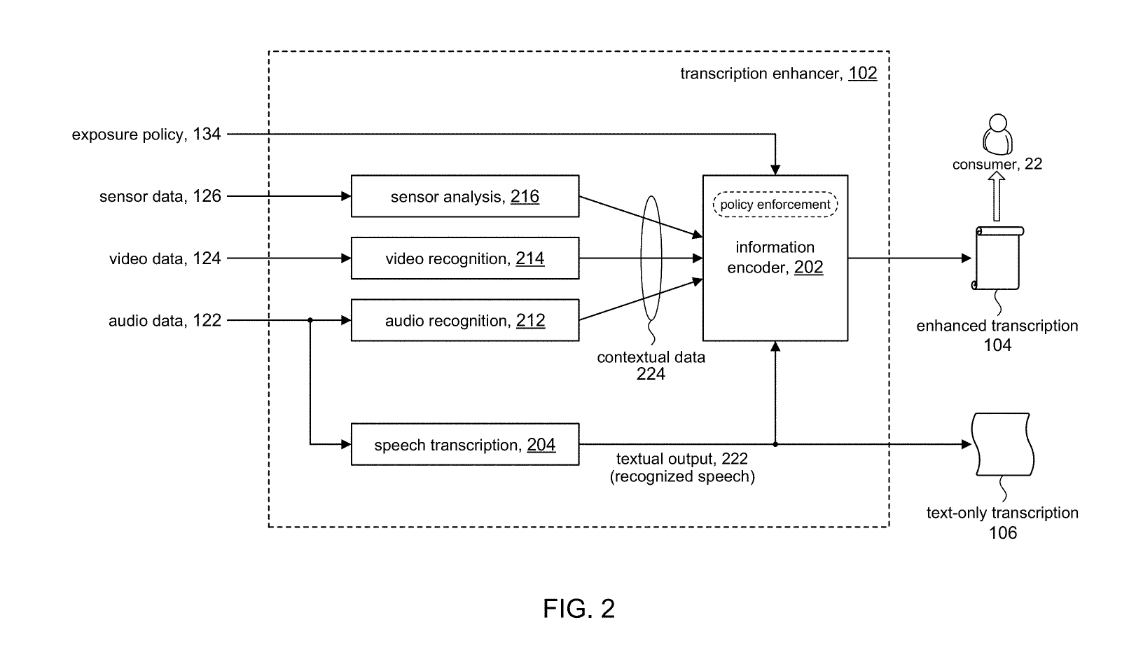

FIG. 2 shows details of transcription enhancer 102 in accordance with some embodiments of the present disclosure. For example, the transcription enhancer 102 can include an information encoder 202 to receive a textual output 222 of speech contained in the audio data stream 122 and contextual data 224 to enhance the textual output 222 and produce enhanced transcription 104.

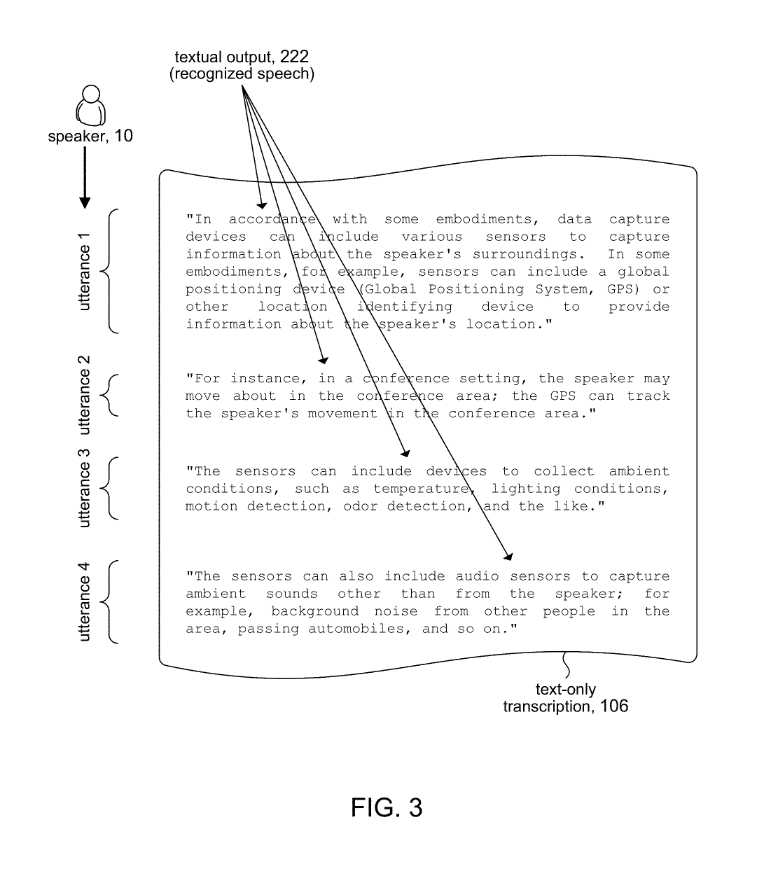

The transcription enhancer 102 can include a speech transcription module 204 to receive the audio data stream 122 and produce the textual output 222, including recognizing speech in utterances spoken by the speaker 10 in the audio data stream 122 and writing it down as textual output 222. The textual output 222 represents an un-enhanced version of speech contained in the audio data stream 122. Referring for a moment to FIG. 3, an example of textual output 222 is shown. As can be seen the textual output 222 can be based on a series of utterances by the speaker 10. Utterances can be defined between pauses by the speaker 10, for example. In some embodiments, the textual output 222 can be written out to a file (e.g., on a disk storage device) and stored as a text-only transcription 106 of the audio data stream 122 for later use.

Continuing with FIG. 2, the figure shows the speech transcription module 204 to be a component of the transcription enhancer 102 in some embodiments. In other embodiments, however, the speech transcription module 204 can be a component that is outside of and separate from the transcription enhancer 102. In some embodiments, for example, the transcription enhancer 102 can be incorporated in a legacy system that already provides speech transcription functionality. In such embodiments, the textual output 222 can be sourced from such a legacy system and provided to the transcription enhancer 102. The remaining discussion will assume the configuration of FIG. 2 with this understanding.

In accordance with the present disclosure, the contextual data 224 can be used to provide context to the textual output 222 and by so doing add meaningful information to the textual output 222. The contextual data 224 can provide a consumer 22 of the textual output 222 with information about the perceptions of and circumstances surrounding the speaker 10 when they spoke. The contextual data 224 can therefore improve the accuracy of how the consumer 22 interprets and understands the actual intended meaning of the speaker 10, and thus reduce the chances of misunderstanding what the speaker 10 intended.

The contextual data 224 can be encoded in any suitable data format. In some embodiments, for example, the encoding can be based on the Extensible Markup Language (XML), although other data formats can be used. In a mobile application, for instance, the JavaScript Object Notation (JSON) data format may be more suitable. Still other formats can be used, for example, DOX, HTML, etc. For the purposes of discussion, the data format used herein will be based loosely on XML. In some embodiments, the contextual data 224 can comprise a stream of data elements (tuples) having the format:
<TYPE: value1, value2, . . . >,
   where TYPE identifies a contextual data type and value1, value2, etc. are specific instances of that contextual data type. For example, one type of contextual data can be EMOTION, to refer to the emotional state of the speaker 10, and instance of the EMOTION type can include happy, sad, neutral, angry, and so on. In accordance with embodiments of the present disclosure, the transcription system 100 can predefine a set of contextual data types to characterize various aspects of the speaker 10 (e.g., emotion state, physical state, etc.) and to characterize various aspects of the speaker's surroundings 12 (location, noise level, time of day, etc.). The information encoder 102 can be configured to process the predefined contextual data types in a predetermined fashion to the textual output 222 to generate enhanced transcription 104.

In some embodiments, the transcription enhancer 102 can include an audio recognition module 212 as a source of the contextual data 224. The audio recognition module 212 can employ voice recognition techniques to analyzed the audio data stream 122 to determine certain characteristics of the speaker 10; for example, based on the tonal content in the voice, the speaker's gender may be ascertained. Based on detected accents in the voice, the speaker's nationality may be ascertained, and so on. In some embodiments, voice recognition techniques may be able to detect the emotional condition of the speaker 10, for example, whether the speaker 10 is excited, stressed, nervous, angry, etc, or their attitude (happy, laughing, crying, joking, etc.). Based on detected stress in the voice, and other vocal queues, the audio recognition module 212 may be able to assess the speaker's physical condition. In addition to characteristics of the speaker 10, in some embodiments, the audio recognition module 212 can extract information about the speaker's surroundings 12; for example, ambient noise levels (quiet, loud), different kinds of noise (music, nearby conversation, heavy or light traffic, etc.). It can be appreciated that the audio data stream 122 can include context that can be helpful in understanding the state of the speaker 10 at the time they spoke.

The information detected or otherwise extracted from the audio data stream 122, in addition to the speaker's speech, can be encoded as contextual data 224. For example, suppose the audio recognition module 212 determines based on an analysis of the audio data stream 122 that the speaker 10 is happy, the audio recognition module 212 can encode that determination in the following data element: <EMOTION: happy> and output the data element as contextual data 224. The contextual data 224 can be a continuous stream of data elements as changes in the speaker's state are detected in the audio data stream. Merely to illustrate this point, depending on the audio data stream 122, the data elements in the stream of contextual data 224 can look like: <EMOTION: happy>, <EMOTION: neutral>, <ATTITUDE: suspicious>, <EMOTION: angry>, and so on.

The transcription enhancer 102 can include a video recognition module 214 as another source of the contextual data 224. The video recognition module 214 can employ various image processing techniques to recognize the speaker 10 and other persons in the video data stream 124. In some embodiments, imaging techniques can perform object detection as well. The video recognition module 214 can detect physical features of the speaker 10, such as gender, age, height, weight, and so on. The speaker's facial expressions can be analyzed to determine if they are smiling, rolling their eyes, nodding in agreement, and so on. The speaker's body language, hand gestures and other movement can be detected and analyzed to estimate the speaker's emotional state. The video recognition module 214 can encode this information as contextual data 224 expressed in the form of data elements. For example, recognition of gender by the video recognition module 124 can be encoded as the data element: <GENDER: male>. As another example, if the video data stream 124 includes video of the speaker laughing, then the video recognition module 124 can encode that piece of information in the following data element: <ATTITUDE: happy, laughing>, and so on. As with the audio data stream 122, a stream of contextual data 224 comprising data elements can be generated to indicate changes in the speaker's state or surroundings that are detected in the video data stream 124. It can be appreciated that the video data stream 124 can contain visual queues about the speaker 10 and their surroundings that can provide additional context, which can be helpful in understanding the speaker 10 at the time they spoke.

The transcription enhancer 102 can include a sensor analysis module 216 as yet another source of the contextual data 224. The sensor analysis module 216 can comprise distinct analytical modules to process information from different sensors 116 that can be deployed at the speaker's location. Information (e.g., location, temperature, noise levels, etc.) obtained by the sensor analysis module 216 can be similarly encoded as explained above, in data elements.

The information encoder 202 can include policy enforcement to restrict/deny the use of certain information according to the exposure policy 134. As mentioned above, the speaker 10 and/or an administrator 136 can establish rules for how certain information is used. For example, the speaker 10 may not want their personal information (e.g., gender, age, etc.) exposed. The policy enforcement processing can identify certain types (e.g., GENDER, AGE, etc.) in the contextual data 224 that should not be used by the information encoder 202 for the purposes of enhancing the textual output 222. In some embodiments, the policy enforcement may limit certain types (e.g., AGE) to specific values. For example, while the actual age may not be permitted, an age range may be permitted.

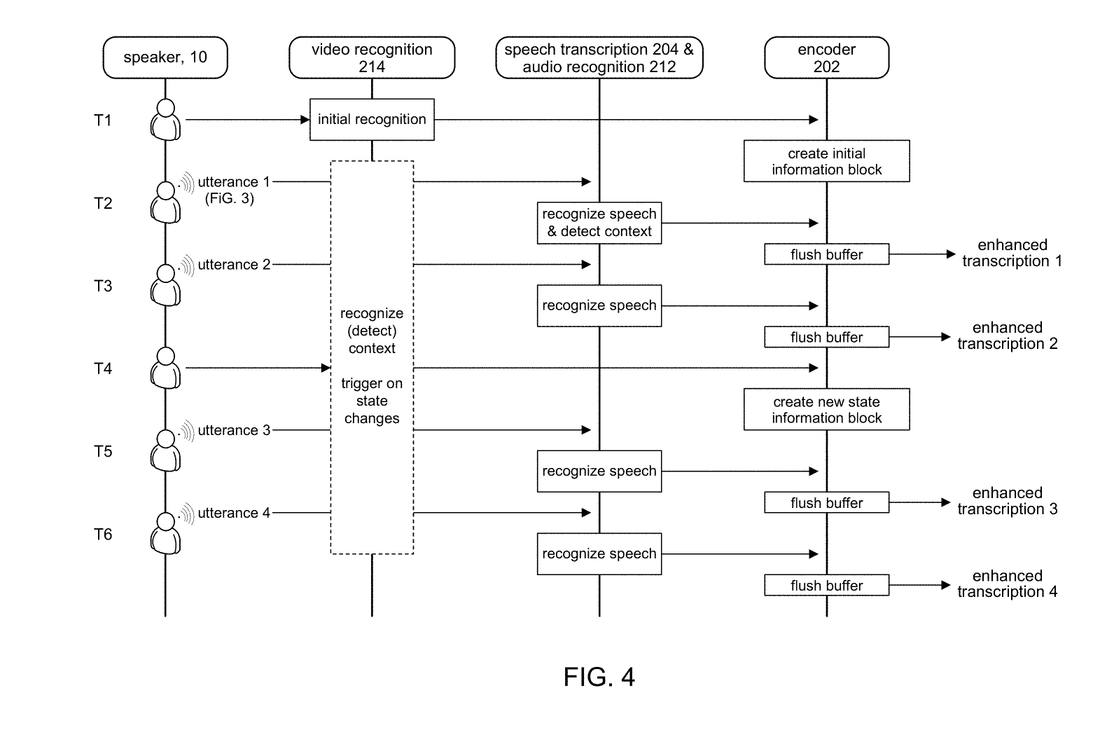

FIG. 4 shows an illustrative communication flow among components of the transcription enhancer 102 shown in FIG. 2 in accordance with some embodiments. As the speaker 10 talks, utterances 1-4 spoken by the speaker 10 and/or detected state changes can serve to trigger the information encoder 102 to generate enhanced transcriptions 1-4. The enhancements can be based on contextual data 224 generated, for example, by sources 212, 214, 216 and provided to the information encoder 102. For purposes of explanation, the utterances shown in FIG. 3 will be used as examples of utterances 1-4 in FIG. 4.

At time T1, for instance, the speaker 10 may make their initial appearance. For example, the speaker 10 may initiate a video conference with another person. The video recognition module 214 may recognize from the video data stream 124 various characteristics of the speaker 10, such as gender, age, and the like. The video recognition module 214 can create suitable contextual data 224 comprising one or more data elements, which can then be communicated to the information encoder 102. As explained above, the contextual data 224 can comprise a stream of data elements, for example:
<TYPE1: val> <TYPE2: val1, val2> <TYPE3: val> . . . .
   The information encoder 102 can create and buffer an initial information block using the received stream of contextual data 224.

In order to reduce clutter in FIG. 4, the sensor analysis module 216 is not shown, although it should be understood that contextual data 224 can be received from the sensor analysis module 216 as well, such as location of the speaker 10, temperature, etc. It is also noted that FIG. 4 shows the speech transcription and audio recognition modules 204, 212 are combined because speech recognition/transcription tends to go hand in hand with detecting some context and so transcribed speech can be accompanied by contextual data 224. It should be appreciated, however, that the audio recognition module 212 can nonetheless detect context based on audio other than speech (e.g., background noise), and the audio recognition module 212 can generate contextual data 224 without necessarily transcribing any speech.

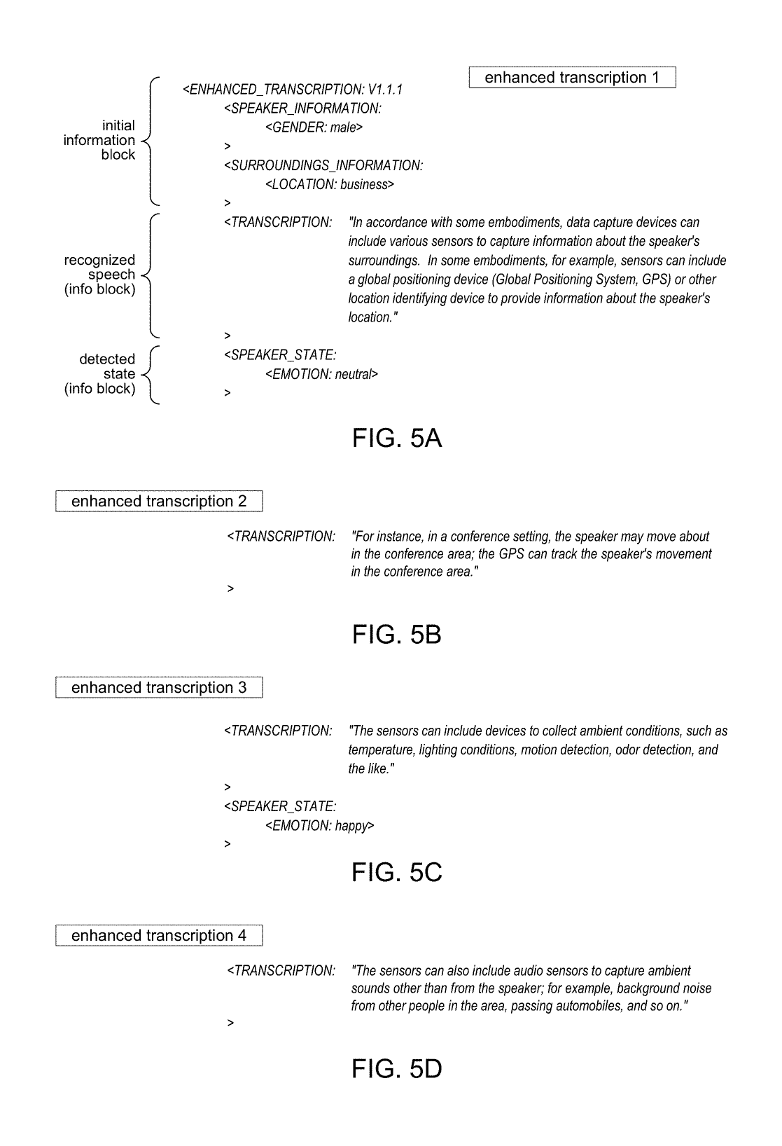

At time T2, suppose the speaker 10 speaks utterance 1 (FIG. 3). The speech transcription module 204 can detect the utterance in the audio data stream 122 and recognize speech content in the utterance. In accordance with some embodiments, the detection of an utterance can serve to trigger a flush operation, where contextual data 224 collected in a buffer up to the point of the utterance can be output along with a transcription of the utterance. For example, utterance 1 at time T2 can produce enhanced transcription 1, an example of which is shown in FIG. 5A. In addition, the audio recognition module 212 can detect any context information in the utterance. For example, if there is excitement in the speaker's voice, the audio recognition module 212 may detect the excitement and generate appropriate contextual data 224 (e.g., <EMOTION, neutral>) that corresponds to the utterance. It is noted that such contemporaneous contextual data can be generated by the video recognition module 214 and/or the sensor analysis module 216.

FIG. 5A shows some details of the XML-based data format used to represent an enhanced transcription 104 in accordance with some embodiments of the present disclosure. The enhanced transcription 104 can be an XML-based document comprising groups of information blocks. There is an initial information block that can include bookkeeping information in accordance with a properly defined and properly constructed document. Information blocks can encapsulate contextual information to be stored in the enhanced transcription 104, and comprises contextual data 224 from recognition modules 212-216. For example, the initial information block can include contextual information detected by the video recognition module 214 when the speaker 10 is first detected, such as speaker information (to provide context about the speaker, e.g., gender, age, etc.) and surroundings information (to provide context about the speaker's surroundings, e.g., location, temperature, weather conditions, etc.).

FIG. 5A illustrates additional information blocks that comprise the enhanced transcription. The transcription of utterance 1, for example, can be encapsulated in an information block for storing transcribed text. The contextual data representing a state of the speaker 10 (e.g., <EMOTION, neutral>) can be encapsulated in an information block that represents the speaker's state. In accordance with the present disclosure, the textual transcription of utterance 1 is enhanced by these additional information blocks, which contextual information about the speaker 10, such as physical aspects, location, emotional state, and so on. The additional contextual information can facilitate a more accurate understanding of the speaker's intended meaning. An accurate understanding of the speaker's intentions can avoid misunderstandings, which can be detrimental to the relationship between speaker and listener, and avoid time consuming activity to rectify any such misunderstandings.

At time T3, another utterance 2 (FIG. 3) may be spoken by the speaker 10 and detected by the speech transcription module 204. In this instance, however, the example shows that there was no detection of any change in the speaker's state. The buffer is flushed to output the transcribed utterance as enhanced transcription 2. Referring to FIG. 5B, the enhanced transcription 2 comprises a transcription of utterance 2 encapsulated in the XML-based data format to produce another information block.

At time T4, the speaker's state (emotional, physical) may change. For example, the speaker 10 may raise their hands in exasperation, or be smiling, and so on. The video recognition module 214 can be monitoring its video data stream 124 to detect any changes in the state of the speaker 10, whether the state of the speaker themselves, or their surroundings. The state change can generate contextual data 224 that can then be sent to the information encoder 102. A new information block can be created and buffered that represents the state change.

At time T5, another utterance 3 (FIG. 3) may be spoken by the speaker 10 and detected by the speech transcription module 204. The utterance can result in a flush operation on the buffer to produce enhanced transcription 3. Referring for a moment to FIG. 5C, the enhanced transcription 3 comprises a transcription of utterance 3 encapsulated in the XML-based data format and an information block that represents the new emotional state of the speaker 10: <EMOTION: happy>.

At time T6, another utterance 4 (FIG. 3) may be spoken by the speaker 10 and detected by the speech transcription module 204. The buffer is flushed in response to the utterance to output the transcribed utterance as enhanced transcription 4. Referring to FIG. 5D, the enhanced transcription 4 comprises a transcription of utterance 4 encapsulated in the XML-based data format.

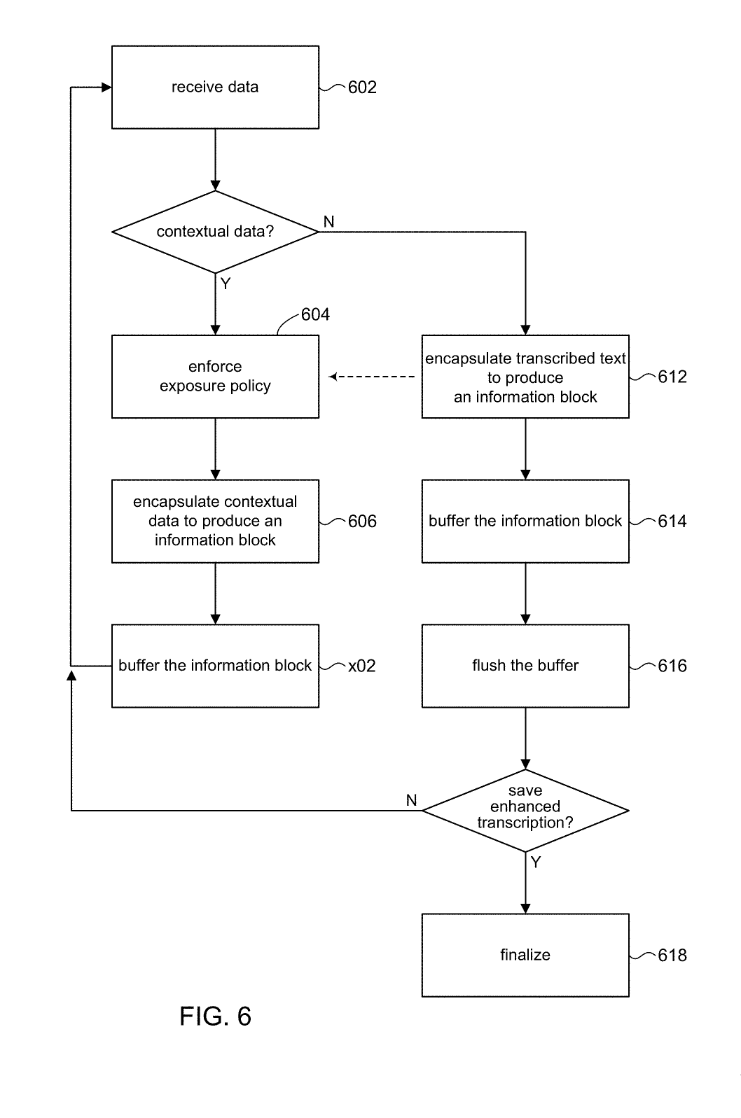

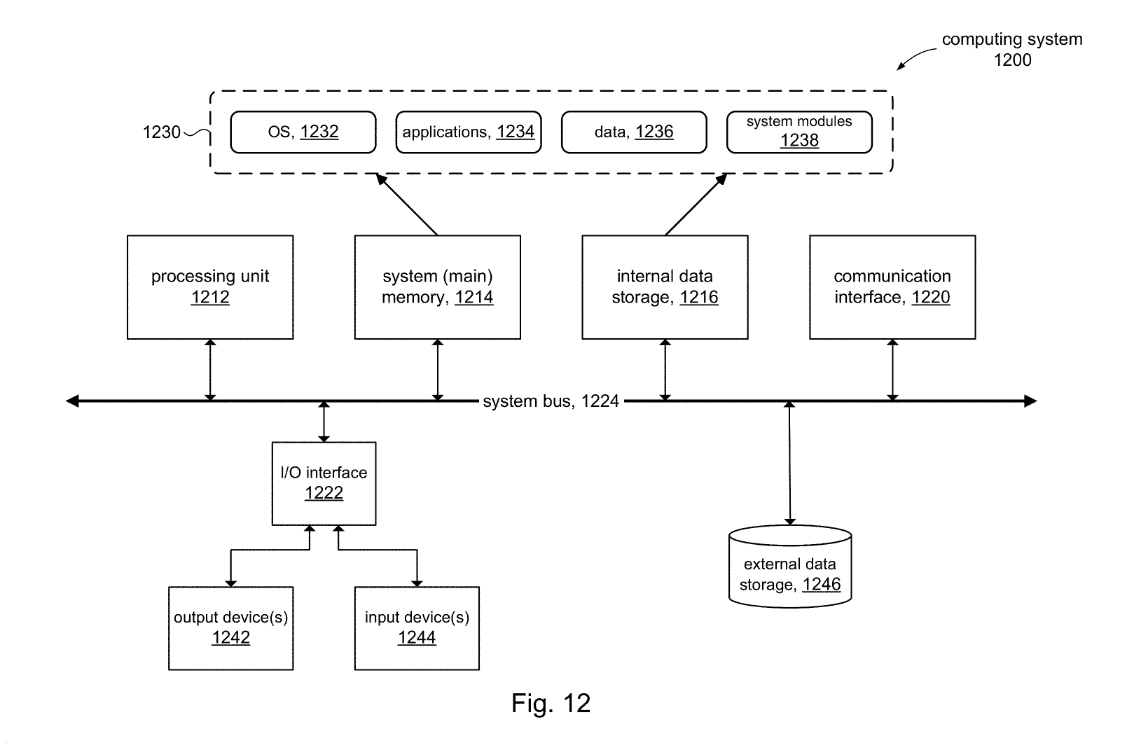

Referring to FIG. 6 and other figures, the discussion will now turn to a high level description of operations and processing by the information encoder 202 (FIG. 2) to provide enhanced transcriptions in accordance with the present disclosure. In some embodiments, for example, the information encoder can include computer executable program code, which when executed by a processing unit (e.g., 1212, FIG. 12), can cause the information encoder to perform processing in accordance with FIG. 6. The operation and processing blocks described below are not necessarily executed in the order shown, and can be allocated for execution among one ore more concurrently executing processes and/or threads.

At block 602, the information encoder can receive data from an upstream module. For example, the information encoder can receive recognized speech, expressed as transcribed text, from the speech transcription module 204. The transcribed text can represent an utterance of the speaker 10. An utterance can be defined by a pause in speaking for a predetermined period of time. The information encoder can receive contextual data 224 from the audio recognition or video recognition modules 212, 214, or from the sensor analysis module 216. Contextual data from a module (e.g., 212) can comprise a stream of data elements. If the received data is contextual data, then processing can proceed to block 604; otherwise, processing can proceed to block 612

### Processing Contextual Data

At block 604, the information encoder receives contextual data. As explained above, the contextual data includes any information that can be captured by a capture device (e.g., 212, 214, 216) and/or inferred captured information. As noted above certain contextual data (e.g., gender, ethnicity, age, medical condition, etc.) about the person may be deemed to be inappropriate. National and regional privacy laws may restrict the use of certain contextual data, cultural and social norms may dictate what is appropriate and what is not, and so on. In accordance with the present disclosure, the information encoder can enforce an exposure policy on the contextual data to restrict whether and how the data can be used. In some instances, for example, the enforcement policy can include a list of context types (e.g., GENDER, ETHNICITY, etc.) that cannot be used, in which case, that particular contextual data can simply be ignored and not processed. In some instances, the enforcement policy can restrict the kind of information contained in the contextual data. For example, the enforcement policy may require that the context type ETHNICITY be restricted to geographical area rather specify a particular ethnicity. In some embodiments, for example, the information encoder can be configured to map various specific ethnicities to geographic regions; for instance, the contextual data <ETHNICITY: Japanese> can be mapped to <ETHNICITY: Asian>.

At block 606, the information encoder can encapsulate the contextual data to create an information block. The information encoder can have a plurality of predefined information blocks to encapsulate different kinds of contextual information; e.g., speaker information, surroundings information, speaker state information, and so on. The information encoder can map the contextual data to one of the information block types. Referring for a moment to FIG. 5A, for example, the contextual data (e.g., received from the audio recognition module 212)
<EMOTION: neutral>
   may map to an information block type for speaker state. The contextual data can be encapsulated to define the information block

<SPEAKER_STATE:
<EMOTION: neutral>
>

The information block is a higher level structure that comprises the enhanced transcription 104 (FIG. 2), which is the output of the information encoder. An information block can encapsulate more than one piece of contextual data. For example, the speaker state shown above can include information about the speaker's detected physical condition, mental condition, etc., in addition to the speaker's detected emotional state.

At block 608, the information encoder can buffer the generated information block in a buffer. Processing can then return to block 602 to continue receiving data.

### Processing Transcribed Text

At block 612, the information encoder can receive the transcribed text, for example, from the speech transcription module 204. As the name implies, the transcribed text is a text-only representation of an utterance recognized and transcribed in the speech transcription module 204. The information encoder can encapsulate the received transcribed text to produce an text-only information block that can then be incorporated in the higher level data structure of the enhanced transcription. FIG. 5A, for example, illustrates and example of this type of information block. In some instances, the transcribed text may include contextual data that was generated (e.g., by audio recognition module 212) at the time the speech was transcribed. For example, the spoken words may have been spoken with a certain level of stress in the speaker's voice. The stress may be detected and the resulting contextual data can be provided along with the transcribed text. That contextual data can be processed through block 604 as indicated in FIG. 6 by the path from block 612 to block 604.

At block 614, the information encoder can buffer the encapsulated transcribed text. If contextual data accompanied the transcribed text as explained above, then the processed contextual data can be buffered with the transcribed text.

At block 616, the information encoder can flush the buffer in response to receiving and processing transcribed text. In some embodiments, the receiving of transcribed text can serve as a trigger to flush the buffer and write the buffer contents to a file that constitutes the enhanced transcription 104. Flushing the buffer will write out previously buffered information blocks containing contextual data and the information block containing the transcribed text. Processing can return to block 602 to receive additional data. If an indication is received to save the enhanced transcription file, then processing can proceed to block 618

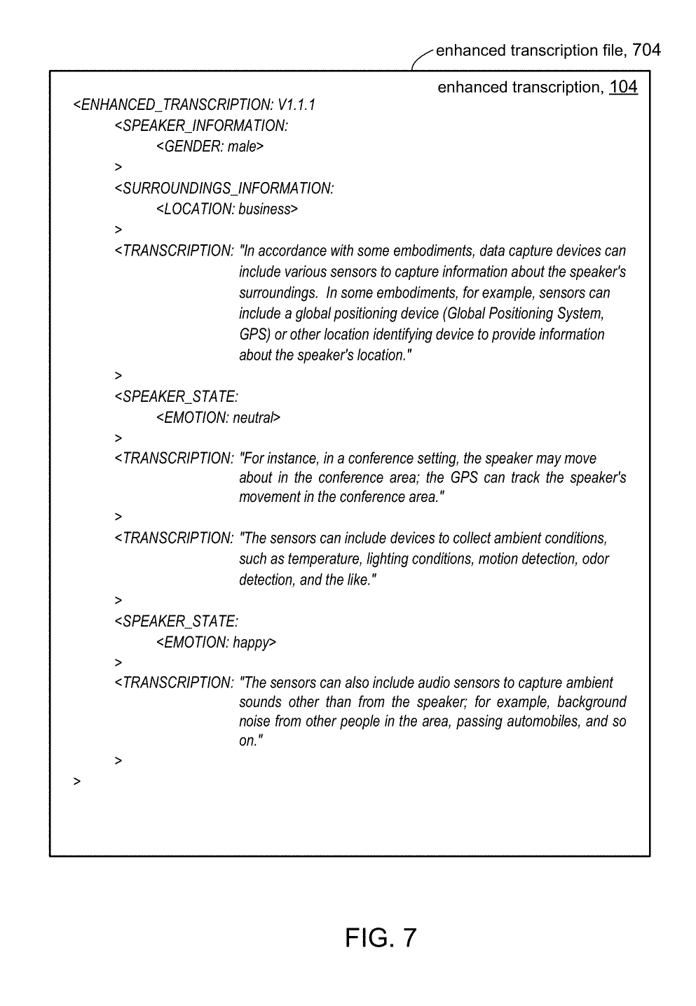

At block 618, the information encoder can finalize the enhanced transcription file. This may include output some final bookkeeping data to properly define the file; for example, a closing “>” at the end of the file to match the opening “<ENHANCED_TRANSCRIPTION: V1.1.1”. FIG. 7 shows an example of a final enhanced transcription file 704.

The enhanced transcription 104 (e.g., FIG. 7) can be expressed in a suitable markup language that can later be rendered. In some embodiments, for example, the enhanced transcription 104 is expressed in an XML-based markup language. In accordance with the present disclosure, the enhanced transcription 104 can be rendered to produce an enriched rendering that can be presented on a computer display, printed, etc. The enriched rendering can include avatars, emoji's, and other graphical embellishments to visually enhance the text-only transcription of the speaker's spoken words.

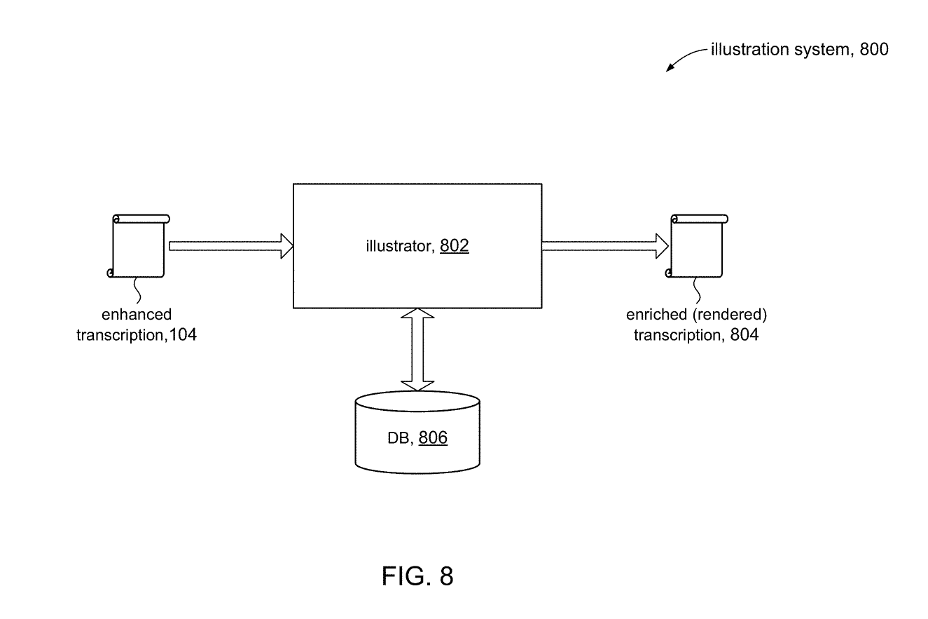

FIG. 8 shows a illustration system 800 in accordance with some embodiments of the present disclosure for producing enriched renderings. An illustrator 802 can receive the enhanced transcription 104 and synthesize an enriched rendering 804 of the transcription. The illustrator system 800 can include a database 806 of images and other graphical elements that can be incorporated in the enriched rendering 804.

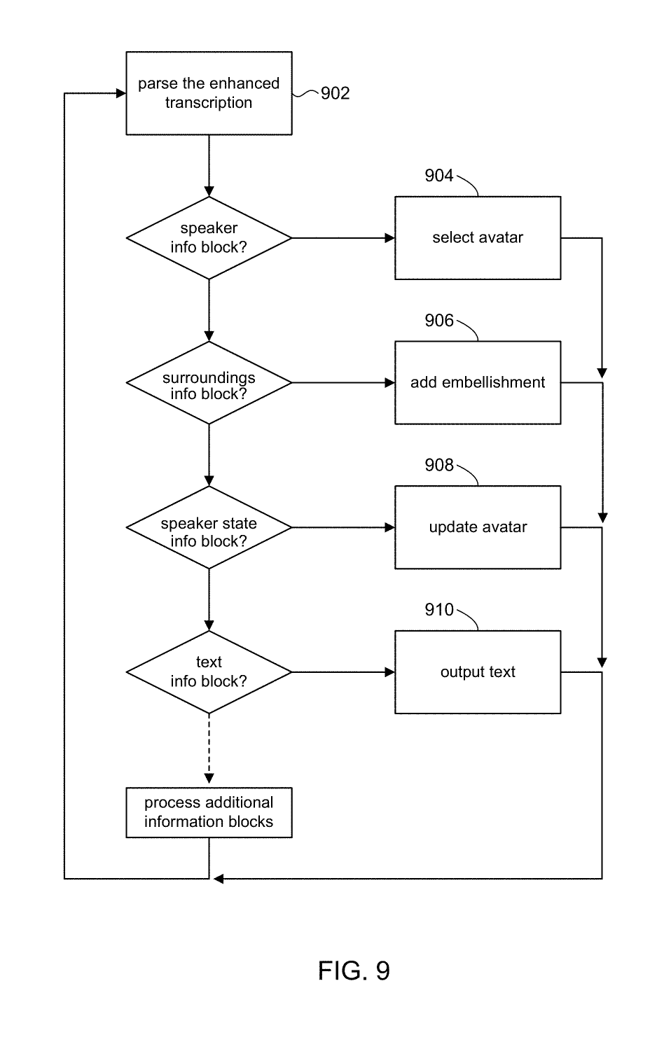

Referring to FIG. 9, the discussion will now turn to a high level description of operations and processing by the illustrator 802 to produce an enriched rendering an enhanced transcription in accordance with the present disclosure. In some embodiments, for example, the illustrator can include computer executable program code, which when executed by a processing unit (e.g., 1212, FIG. 12), can cause the illustrator to perform processing in accordance with FIG. 9. The operation and processing blocks described below are not necessarily executed in the order shown, and can be allocated for execution among one ore more concurrently executing processes and/or threads.

The basic flow is to process each information block in the enhanced transcription to create rendering of the transcribed text that is enriched with contextual information based on the circumstances of the speaker and their surrounding as they spoke. For each information block in the enhanced transcript, a graphical element can be selected from the database 806 and rendered. The rendering can be on a computer display device. The rendering can be to a print file for output on a printer, and so on.

At block 902, the illustrator can receive and parse the enhanced transcription to identify the information blocks to be rendered. In the example of FIG. 7, for instance, the information blocks include SPEAKER_INFORMATION, SURROUNDINGS_INFORMATION, TRANSCRIPTION, and SPEAKER_STATE.

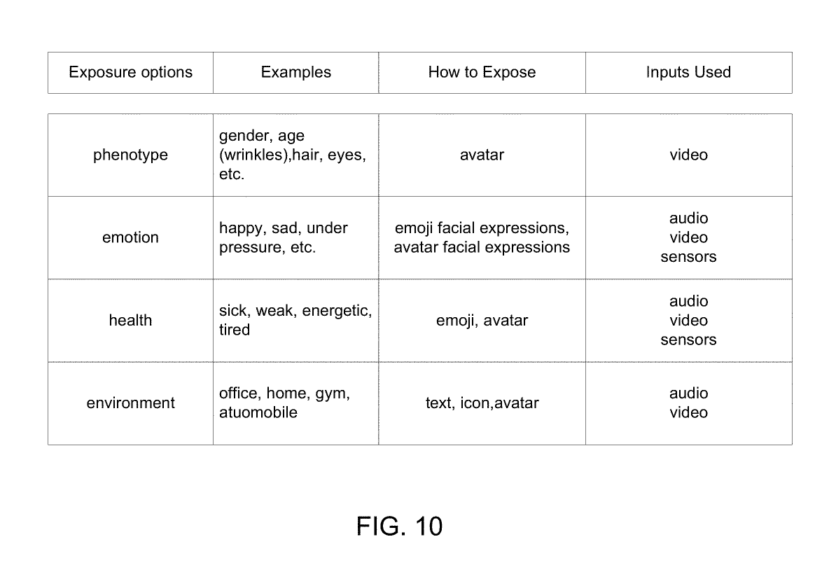

At block 904, the illustrator can render an avatar (or other suitable graphic) that represents the speaker when a speaker information block is encountered. Avatars can be predefined according to various characteristics set forth in the speaker information block, such as gender, ethnicity, age, and so on. In some embodiments, the rendering can be controlled according to the exposure policy 134. Referring for a moment to FIG. 10, a features table represents different features about the speaker that can be exposed. The table can be divided into groups that the speaker can select or de-select (e.g., via policy manager 132) in order to set their desired exposure level. Imagery can be included in the rendering according to the exposure level. For instance, if the speaker does not want to reveal their appearance, emoji's can be presented instead of an avatar. In some embodiments, the system may automatically determine avatars based on the comfort levels experienced by the speaker, or use default profiles as determined from the preferences of similar users. In any case, the speaker can override suggested avatars, and the system can preserve a last used avatar (selection) for the use in subsequent sessions.

At block 906, the illustrator can add one or more embellishment to the rendering when a surroundings information block is encountered. For example, if the speaker is outside, the rendering can include suitable outdoor graphics (e.g., tree, using an outdoor scene as a background image, etc.).

At block 908, the illustrator can update the speaker's avatar when a speaker state information block is encountered, in order to reflect the speaker's current state (physical, mental, attitude, etc.). For example, the initial avatar may represent a neutral disposition. If the speaker become agitated, that change in emotional can indicated by a speaker state information block. The illustrator can select and render an avatar to indicate the speaker is agitated. The accompanying text can now be read with that context in mind, and interpreted by the reader accordingly.

At block 910, the illustrator can render the text contained in a text information block. In some embodiments, the rendered text can be plain text. In other embodiments, the rendered text can be rendered in a way that is indicative of the speaker's emotional state (e.g., as indicated in a speaker state information block). For example, if the speaker's state indicates a very subdued state of mind, the rendered text may be rendered using a smaller font size, or if the speaker is excited then the text can be rendered with bolding or underlining. It will be appreciated that other types of information blocks can be defined and rendered.

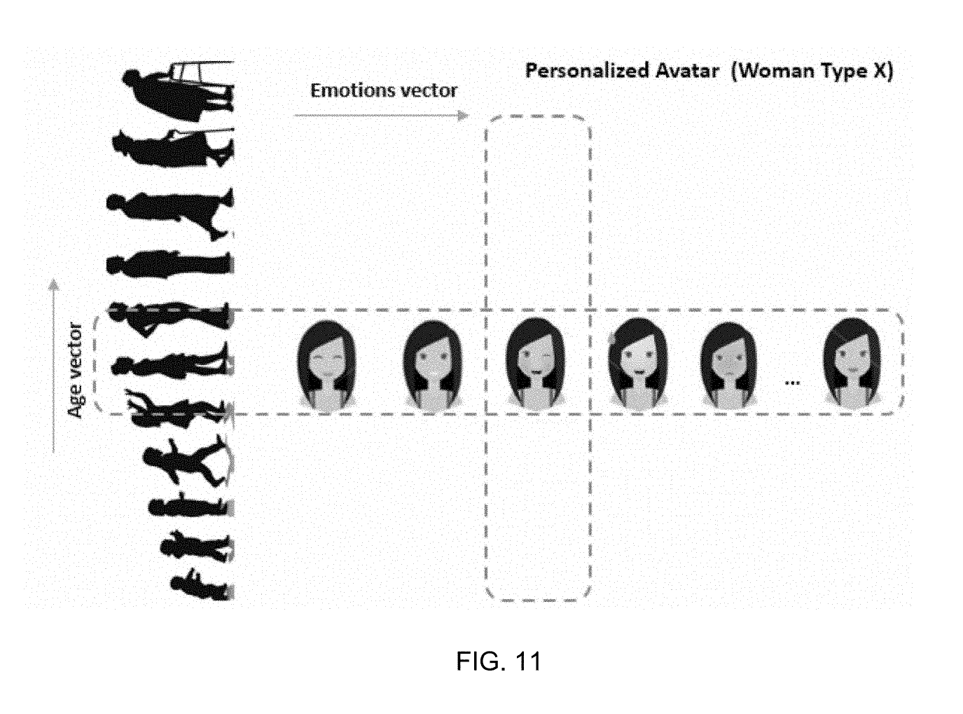

Referring to FIG. 11, the selection of avatars for rendering (e.g., blocks 904, 908, FIG. 9) can be made using a multi-dimensional matrix of avatars. Each dimension can represent different aspects of the speaker. FIG. 11 shows two axes based an AGE context and an EMOTION context, although it will be appreciated that other contextual information can be used to define additional axes. Contextual information that is quantitative in nature (e.g., age, temperature) can be readily represented on an axis. Qualitative contextual information can be arbitrarily arranged on an axis or ranked by some suitable criteria; e.g., emotions can be ranked from anger to neutral to happy. Each avatar can be customized for the combination of contextual information used to access the avatar.

In some embodiments, a speaker can initialize a set of avatars for themselves. In this initialization process, external appearance information can be collected; e.g., from captured video. An avatar can be created according to this information, providing a basic perspective of the speaker, though, without exposing their real identity. In addition to this avatar, additional avatar images of the speaker can be created automatically. These avatars present the speaker in different moods, environments, health states, etc. Each avatar can be saved by an ID which specifies the condition of the speaker.

FIG. 12 is a simplified block diagram of an illustrative computing system 1200 for implementing one or more of the embodiments described herein (e.g., information encoder 202, illustrator 802, etc.). The computing system 1200 can perform and/or be a means for performing, either alone or in combination with other elements, operations in accordance with the present disclosure. Computing system 1200 can also perform and/or be a means for performing any other steps, methods, or processes described herein.

Computing system 1200 can include any single- or multi-processor computing device or system capable of executing computer-readable instructions. Examples of computing system 1200 include, for example, workstations, laptops, servers, distributed computing systems, and the like. In a basic configuration, computing system 1200 can include at least one processing unit 1212 and a system (main) memory 1214.

Processing unit 1212 can comprise any type or form of processing unit capable of processing data or interpreting and executing instructions. The processing unit 1212 can be a single processor configuration in some embodiments, and in other embodiments can be a multi-processor architecture comprising one or more computer processors. In some embodiments, processing unit 1212 can receive instructions from program and data modules 1230. These instructions can cause processing unit 1212 to perform operations in accordance with the various disclosed embodiments (e.g., FIGS. 6, 9) of the present disclosure.

System memory 1214 (sometimes referred to as main memory) can be any type or form of storage device or storage medium capable of storing data and/or other computer-readable instructions, and comprises volatile memory and/or non-volatile memory. Examples of system memory 1214 include any suitable byte-addressable memory, for example, random access memory (RAM), read only memory (ROM), flash memory, or any other similar memory architecture. Although not required, in some embodiments computing system 1200 can include both a volatile memory unit (e.g., system memory 1214) and a non-volatile storage device (e.g., data storage 1216, 1246).

In some embodiments, computing system 1200 can include one or more components or elements in addition to processing unit 1212 and system memory 1214. For example, as illustrated in FIG. 12, computing system 1200 can include internal data storage 1216, a communication interface 1220, and an I/O interface 1222 interconnected via a system bus 1224. System bus 1224 can include any type or form of infrastructure capable of facilitating communication between one or more components comprising computing system 1200. Examples of system bus 1224 include, for example, a communication bus (such as an ISA, PCI, PCIe, or similar bus) and a network.

Internal data storage 1216 can comprise non-transitory computer-readable storage media to provide nonvolatile storage of data, data structures, computer-executable instructions, and so forth to operate computing system 1200 in accordance with the present disclosure. For instance, the internal data storage 1216 can store various program and data modules 1230, including for example, operating system 1232, one or more application programs 1234, program data 1236, and other program/system modules 1238, for example, to support and perform various processing and operations in information encoder 202.

Communication interface 1220 can include any type or form of communication device or adapter capable of facilitating communication between computing system 1200 and one or more additional devices. For example, in some embodiments communication interface 1220 can facilitate communication between computing system 1200 and a private or public network including additional computing systems. Examples of communication interface 1220 include, for example, a wired network interface (such as a network interface card), a wireless network interface (such as a wireless network interface card), a modem, and any other suitable interface.

Computing system 1200 can also include at least one output device 1242 (e.g., a display) coupled to system bus 1224 via I/O interface 1222, for example, to provide access to an administrator. The output device 1242 can include any type or form of device capable of visual and/or audio presentation of information received from I/O interface 1222.

Computing system 1200 can also include at least one input device 1244 coupled to system bus 1224 via I/O interface 1222, e.g., for administrator access. Input device 1244 can include any type or form of input device capable of providing input, either computer or human generated, to computing system 1200. Examples of input device 1244 include, for example, a keyboard, a pointing device, a speech recognition device, or any other input device.

Computing system 1200 can also include external data storage subsystem 1246 coupled to system bus 1224. In some embodiments, the external data storage 1246 can be accessed via communication interface 1220. External data storage 1246 can be a storage subsystem comprising a storage area network (SAN), network attached storage (NAS), virtual SAN (VSAN), and the like. External data storage 1246 can comprise any type or form of block storage device or medium capable of storing data and/or other computer-readable instructions. For example, external data storage 1246 can be a magnetic disk drive (e.g., a so-called hard drive), a solid state drive, a floppy disk drive, a magnetic tape drive, an optical disk drive, a flash drive, or the like.

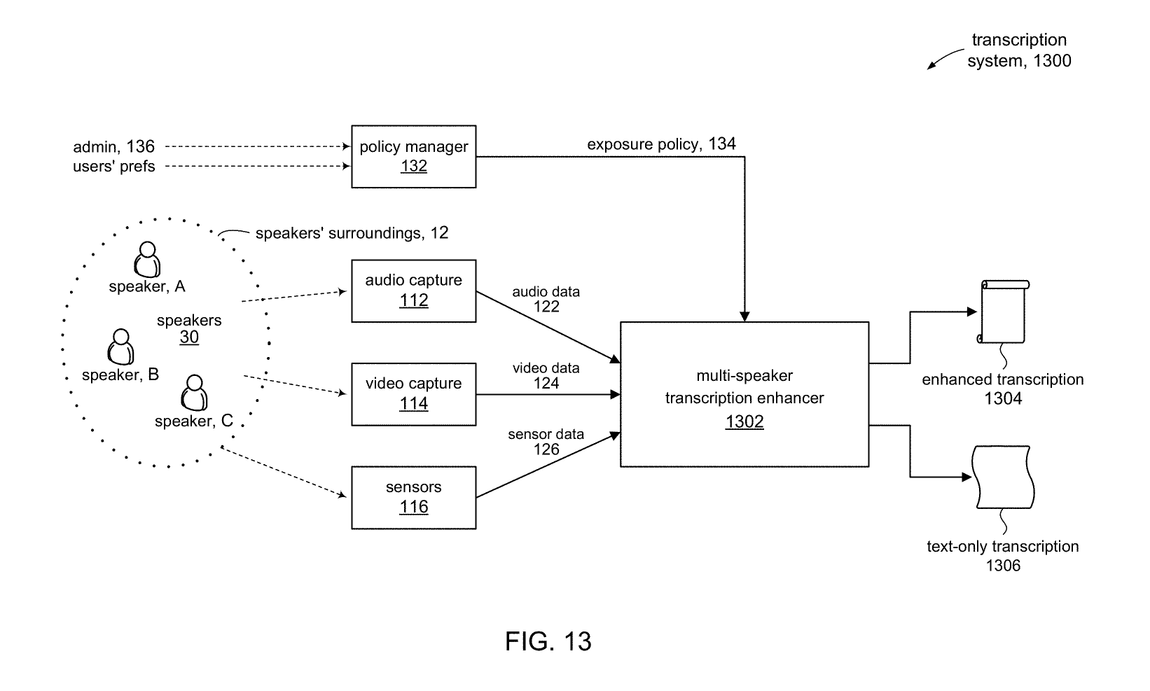

FIG. 13 shows a transcription system 1300 configured for multiple speakers 30, where the transcription enhancer 102 in the single speaker transcription system 100 of FIG. 1 is replaced by a multi-speaker transcription enhancer 1302 that provides that same processing as transcription enhancer 102, but includes information that identifies a speaker from among the several speakers 30 (e.g., speakers in a meeting, on a conference call, etc.). The multi-speaker transcription enhancer 1302 produces a speaker-identified enhanced transcription 1304 and speaker-identified text-only transcription 1306, which include the same kind of contextual information as in their corresponding counterparts described above, but further includes information that identifies the speakers.

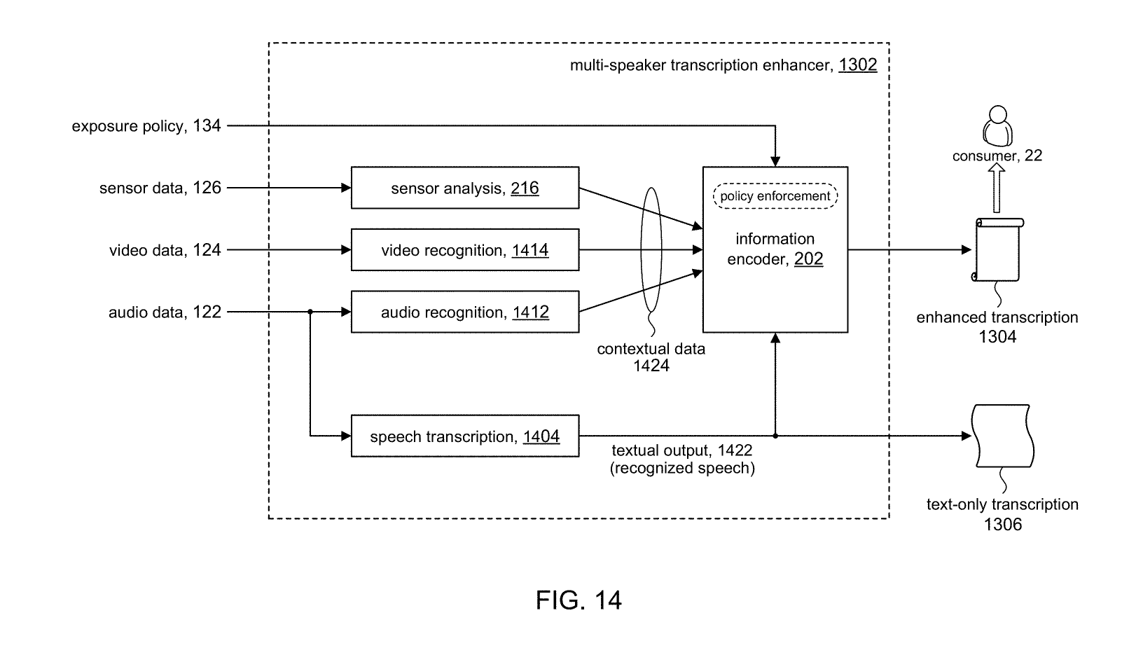

FIG. 14 shows details of the multi-speaker transcription enhancer 1302 in accordance with some embodiments. The modules 1404, 1412, and 1414 provide the same functionality as their corresponding counterparts shown in FIG. 2, but include the additional capability of speaker identification. For example, the speech transcription module 1404 can detect a change from one speaker to another. Information can be included in the textual output 1422 that identifies the speaker, for example:

```
        “SPKR 1: how was the flight”
  “SPKR 2: it was fine but the flight was late”
“SPKR 1: oh yes I was late on my flight as well”
      “SPKR 1: let's start the meeting”
                    :
```

Likewise, the audio recognition module 1412 can recognize the voice (e.g., tone, register) of different speakers and include speaker identification information with the contextual data 1424. In some embodiments, the contextual data 1424 can have the format:
<TYPE: speaker=“SPKRx”, value1, value2, . . . >,
   where TYPE identifies a contextual data type and value1, value2, etc. are specific instances of that contextual data type, as described above; and speaker=“SPKRx” identifies the speaker with whom the contextual data is associated, where x identifies the speaker.

The video recognition module 1414 can identify different speakers in the video data stream 124 using suitable facial recognition algorithms and include speaker identification information with the contextual data 1424.

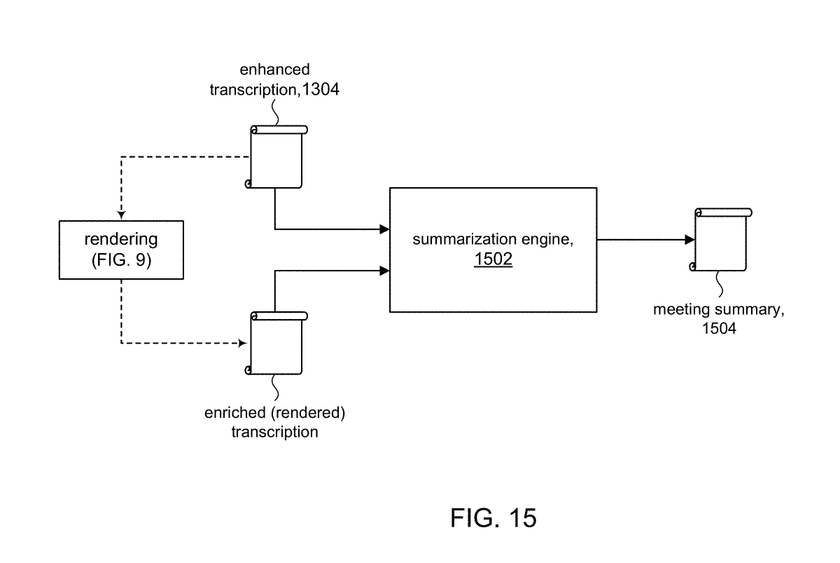

FIG. 15 shows a summarization engine 1502 that can input an enhanced transcription 1304 (or an enriched transcription rendered from the enhanced transcription 1304) to produce a meeting summary. Contextual information in the enhanced transcription 1304 can include mood context such as expressions and attitude of the meeting participants. The summarization engine 1502 can analyze mood context and other contextual information to make produce a meeting summary. For example, the summarization engine may determine that a decision had not been reached due to concerns raised by some participants and set out a meeting summary that reflects the overall mood of the meeting and recommend a subsequent meeting be held. The summarization engine may determine that a conference call was successful based on contextual information that indicated low stress levels, the presence of laughter, smiling or neutral faces of the participants, etc., and set out a meeting summary that indicated a successful meeting.

The following examples pertain to additional embodiments in accordance with the present disclosure. Various aspects of the additional embodiments can be variously combined with some aspects included and others excluded to suit a variety of different applications.

In some embodiments, a method comprises receiving a speaker's captured data comprising audio data, video data, and sensor data; and generating an enhanced transcription of spoken input contained in the audio data, including: performing speech recognition on the audio data to produce a text-only transcription of spoken input contained in the audio data; and detecting indications of state changes in the speaker's state based on the audio data, video data, and sensor data, and in response to detecting a state change in the speaker's state: determining context information from the audio data, video data, and sensor data captured at the time of detecting the state change; generating one or more data elements representative of the context information; and combining the one or more data elements with the text-only transcription to enhance the text-only transcription with information indicative of changes in the speaker's state, thereby adding context to the text-only transcription to facilitate a more accurate understanding of the text-only transcription.

In some embodiments, the method further comprises using an exposure policy associated with the speaker to limit the use of some of the context information. The exposure policy prohibits the use of some of the context information.

In some embodiments, the text-only transcription comprises a plurality of transcribed utterances made by the speaker, the method further comprising including data elements that correspond to state changes of the speaker among the plurality of transcribed utterances.

In some embodiments, the further comprises rendering the enhanced transcription to produce a transcription document, including: selecting one or more embellishments based on the data elements in the enhanced transcription; and rendering the one or more embellishments along with rendering the text-only transcription.

In some embodiments, the method further comprises generating an enhanced transcription of spoken input from a plurality of speakers, including: identifying each of the plurality of speakers; detecting when state changes occur among each of the plurality of speakers; generating data elements representative of context information associated with each of the plurality of speakers based on their state changes; and incorporating the data elements with a text-only transcription of the plurality of speakers' speech to add context to the text-only transcription. The method further comprises generating a summary from the enhanced transcription of spoken input of the plurality of speakers.

In some embodiments, a non-transitory computer-readable storage medium having stored thereon computer executable instructions, which when executed by a computer device, cause the computer device to: receive a speaker's captured data comprising audio data, video data, and sensor data; and generate an enhanced transcription of spoken input contained in the audio data, including to: perform speech recognition on the audio data to produce a text-only transcription of spoken input contained in the audio data; and detect indications of state changes in the speaker's state based on the audio data, video data, and sensor data, and in response to detecting a state change in the speaker's state to: determine context information from the audio data, video data, and sensor data captured at the time of detecting the state change; generate one or more data elements representative of the context information; and combine the one or more data elements with the text-only transcription to enhance the text-only transcription with information indicative of changes in the speaker's state, thereby adding context to the text-only transcription to facilitate a more accurate understanding of the text-only transcription.

In some embodiments, the computer executable instructions, which when executed by the computer device, further cause the computer device to use an exposure policy associated with the speaker to limit the use of some of the context information. The exposure policy prohibits the use of some of the context information.

In some embodiments, the text-only transcription comprises a plurality of transcribed utterances made by the speaker, wherein the computer executable instructions, which when executed by the computer device, further cause the computer device to include data elements that correspond to state changes of the speaker among the plurality of transcribed utterances.

In some embodiments, the computer executable instructions, which when executed by the computer device, further cause the computer device to render the enhanced transcription to produce a transcription document, including: selecting one or more embellishments based on the data elements in the enhanced transcription; and rendering the one or more embellishments along with rendering the text-only transcription.

In some embodiments, the computer executable instructions, which when executed by the computer device, further cause the computer device to generate an enhanced transcription of spoken input from a plurality of speakers, including: identifying each of the plurality of speakers; detecting when state changes occur among each of the plurality of speakers; generating data elements representative of context information associated with each of the plurality of speakers based on their state changes; and incorporating the data elements with a text-only transcription of the plurality of speakers' speech to add context to the text-only transcription.

In some embodiments, the computer executable instructions, which when executed by the computer device, further cause the computer device to generate a summary from the enhanced transcription of spoken input of the plurality of speakers.

In some embodiments, an apparatus comprises: one or more computer processors; and a computer-readable storage medium comprising instructions for controlling the one or more computer processors to be operable to: receive a speaker's captured data comprising audio data, video data, and sensor data; and generate an enhanced transcription of spoken input contained in the audio data, including: perform speech recognition on the audio data to produce a text-only transcription of spoken input contained in the audio data; and detect indications of state changes in the speaker's state based on the audio data, video data, and sensor data, and in response to detecting a state change in the speaker's state: determine context information from the audio data, video data, and sensor data captured at the time of detecting the state change; generate one or more data elements representative of the context information; and combine the one or more data elements with the text-only transcription to enhance the text-only transcription with information indicative of changes in the speaker's state, thereby adding context to the text-only transcription to facilitate a more accurate understanding of the text-only transcription.

In some embodiments, the computer-readable storage medium in the apparatus further comprises instructions for controlling the one or more computer processors to be operable to use an exposure policy associated with the speaker to limit the use of some of the context information. The exposure policy prohibits the use of some of the context information.

In some embodiments, the text-only transcription comprises a plurality of transcribed utterances made by the speaker, wherein the computer-readable storage medium further comprises instructions for controlling the one or more computer processors to be operable to include data elements that correspond to state changes of the speaker among the plurality of transcribed utterances.

In some embodiments, the computer-readable storage medium in the apparatus further comprises instructions for controlling the one or more computer processors to be operable to render the enhanced transcription to produce a transcription document, including: selecting one or more embellishments based on the data elements in the enhanced transcription; and rendering the one or more embellishments along with rendering the text-only transcription.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. A method comprising:
receiving a speaker's captured data; and
generating an enhanced transcription of spoken input contained in the captured data, including:
performing speech recognition on the captured data to produce a text-only transcription of spoken input contained in the captured data; and
detecting indications of state changes in the speaker's state based on the captured data, and in response to detecting a state change in the speaker's state:
determining context information from the captured data captured at the time of detecting the state change;
generating one or more data elements representative of the context information; and
adding context to the text-only transcription to facilitate a more accurate understanding of the text-only transcription by combining the one or more data elements with the text-only transcription to enhance the text-only transcription with information indicative of changes in the speaker's state.

2. The method of claim 1, further comprising using an exposure policy associated with the speaker to limit the use of some of the context information.

3. The method of claim 2, wherein the exposure policy prohibits the use of some of the context information.

4. The method of claim 1, wherein the text-only transcription comprises a plurality of transcribed utterances made by the speaker, the method further comprising including data elements that correspond to state changes of the speaker among the plurality of transcribed utterances.

5. The method of claim 1, further comprising rendering the enhanced transcription to produce a transcription document, including:
selecting one or more embellishments based on the data elements in the enhanced transcription; and
rendering the one or more embellishments along with rendering the text-only transcription.

6. The method of claim 1, further comprising generating an enhanced transcription of spoken input from a plurality of speakers, including:
identifying each of the plurality of speakers;
detecting when state changes occur among each of the plurality of speakers;
generating data elements representative of context information associated with each of the plurality of speakers based on their state changes; and
incorporating the data elements with a text-only transcription of the plurality of speakers' speech to add context to the text-only transcription.

7. The method of claim 6, further comprising generating a summary from the enhanced transcription of spoken input of the plurality of speakers.

8. A non-transitory computer-readable storage medium having stored thereon computer executable instructions, which when executed by a computer device, cause the computer device to:
receive a speaker's captured data comprising audio data, video data, and sensor data; and
generate an enhanced transcription of spoken input contained in the audio data, including to:
perform speech recognition on the audio data to produce a text-only transcription of spoken input contained in the audio data; and
detect indications of state changes in the speaker's state based on the captured data, and in response to detecting a state change in the speaker's state to:
determine context information from the captured data captured at the time of detecting the state change;
generate one or more data elements representative of the context information; and
add context to the text-only transcription to facilitate a more accurate understanding of the text-only transcription by combining the one or more data elements with the text-only transcription to enhance the text-only transcription with information indicative of changes in the speaker's state.

9. The non-transitory computer-readable storage medium of claim 8, wherein the computer executable instructions, which when executed by the computer device, further cause the computer device to use an exposure policy associated with the speaker to limit the use of some of the context information.

10. The non-transitory computer-readable storage medium of claim 9, wherein the exposure policy prohibits the use of some of the context information.

11. The non-transitory computer-readable storage medium of claim 8, wherein the text-only transcription comprises a plurality of transcribed utterances made by the speaker, wherein the computer executable instructions, which when executed by the computer device, further cause the computer device to include data elements that correspond to state changes of the speaker among the plurality of transcribed utterances.

12. The non-transitory computer-readable storage medium of claim 8, wherein the computer executable instructions, which when executed by the computer device, further cause the computer device to render the enhanced transcription to produce a transcription document, including:
selecting one or more embellishments based on the data elements in the enhanced transcription; and
rendering the one or more embellishments along with rendering the text-only transcription.

13. The non-transitory computer-readable storage medium of claim 8, wherein the computer executable instructions, which when executed by the computer device, further cause the computer device to generate an enhanced transcription of spoken input from a plurality of speakers, including:
identifying each of the plurality of speakers;
detecting when state changes occur among each of the plurality of speakers;
generating data elements representative of context information associated with each of the plurality of speakers based on their state changes; and
incorporating the data elements with a text-only transcription of the plurality of speakers' speech to add context to the text-only transcription.

14. The non-transitory computer-readable storage medium of claim 8, wherein the computer executable instructions, which when executed by the computer device, further cause the computer device to generate a summary from the enhanced transcription of spoken input of the plurality of speakers.

15. An apparatus comprising:
one or more computer processors; and
a computer-readable storage medium comprising instructions for controlling the one or more computer processors to be operable to:
receive a speaker's captured data comprising audio data, video data, and sensor data; and
generate an enhanced transcription of spoken input contained in the audio data, including to:
perform speech recognition on the audio data to produce a text-only transcription of spoken input contained in the audio data; and
detect indications of state changes in the speaker's state based on the audio data, video data, and sensor data, and in response to detecting a state change in the speaker's state to:
determine context information from the audio data, video data, and sensor data captured at the time of detecting the state change;
generate one or more data elements representative of the context information; and
add context to the text-only transcription to facilitate a more accurate understanding of the text-only transcription by combining the one or more data elements with the text-only transcription to enhance the text-only transcription with information indicative of changes in the speaker's state.

16. The apparatus of claim 15, wherein the computer-readable storage medium further comprises instructions for controlling the one or more computer processors to be operable to use an exposure policy associated with the speaker to limit the use of some of the context information.

17. The apparatus of claim 15, wherein the exposure policy prohibits the use of some of the context information.

18. The apparatus of claim 15, wherein the text-only transcription comprises a plurality of transcribed utterances made by the speaker, wherein the computer-readable storage medium further comprises instructions for controlling the one or more computer processors to be operable to include data elements that correspond to state changes of the speaker among the plurality of transcribed utterances.

19. The apparatus of claim 15, wherein the computer-readable storage medium further comprises instructions for controlling the one or more computer processors to be operable to render the enhanced transcription to produce a transcription document, including:
selecting one or more embellishments based on the data elements in the enhanced transcription; and
rendering the one or more embellishments along with rendering the text-only transcription.

20. The apparatus of claim 15, wherein the computer-readable storage medium further comprises instructions for controlling the one or more computer processors to be operable to generate an enhanced transcription of spoken input from a plurality of speakers, including:
identifying each of the plurality of speakers;
detecting when state changes occur among each of the plurality of speakers;
generating data elements representative of context information associated with each of the plurality of speakers based on their state changes; and
incorporating the data elements with a text-only transcription of the plurality of speakers' speech to add context to the text-only transcription.

21. The apparatus of claim 15, wherein the text-only transcription comprises a plurality of transcribed utterances made by the speaker, wherein the computer-readable storage medium further comprises instructions for controlling the one or more computer processors to be operable to generate a summary from the enhanced transcription of spoken input of the plurality of speakers.
